(19) United States
(12) Patent Application Publication
(10) Pub. No.: US 2011/0152164 A1
(43) Pub. Date: Jun. 23, 2011

(54) Wet Wipe Having Improved Cleaning Capabilities

(76) Inventors: Kenneth Bradley Close, New London, WI (US); Lisa Lynne Nickel, Menasha, WI (US); Michael Alan Schmidt, Alpharetta, GA (US); Paulin Pawar, Appleton, WI (US); Corey William Bucher, Wrightstown, WI (US); William George Stoeger, Appleton, WI (US)

(21) Appl. No.: 12/643,500

(22) Filed: Dec. 21, 2009

(51) Int. Cl. C11D 17/00

(52) U.S. Cl. 510/441

(57) ABSTRACT

A wet wipe that is formed from a nonwoven structure that comprises a matrix of at least one meltblown fibrous material and at least one secondary fibrous material is disclosed. A weight ratio of the at least one secondary fibrous material to the at least one meltblown fibrous material may be between about 40/60 to about 90/10. Additionally, the nonwoven structure has a first side with a textured surface having a three-dimensional texture that includes a plurality of peaks and valleys and a second side with a substantially planar surface. The nonwoven structure includes about 150 to about 600 wt. % of a liquid solution to prepare a wet wipe. The difference in a cleaning pickup percentage between the first side and the second side of the wet wipe is less than 30%, more desirably less than 20%, and even more desirably less than 15%.

### BACKGROUND

Wipes have been used in the personal care industry for numerous years, and generally have a low surfactant, high water base for cleaning bodily fluids or wiping up menses. In recent years, however, consumers have begun demanding more out of personal care products, including wipes. For example, various wipes have come into the market containing ingredients for softer wipes or containing actives for disinfecting surfaces. Another example of a desired wipe property is the ability of the wipe to clean a surface such as removing bodily fluids or wiping up menses.

Coform nonwoven structures, which are composites of a matrix of meltblown fibers and a secondary fibrous material (e.g., pulp fibers), have been used as an absorbent layer in a wide variety of applications, including absorbent articles, absorbent dry wipes, wet wipes, and mops. Most conventional coform webs employ meltblown fibers formed from polypropylene homopolymers. One problem sometimes experienced with such coform materials, however, is that the polypropylene meltblown fibers do not readily bond to the secondary fibrous material. Thus, to ensure that the resulting web is sufficiently strong, a relatively high percentage of meltblown fibers are typically employed to enhance the degree of bonding at the crossover points of the meltblown fibers. Additionally, a textured surface may be formed by contacting the meltblown fibers with a foraminous surface having three-dimensional surface contours. Three-dimensional surfaces are expected to provide a better wiping surface for cleaning than substantially planar surfaces.

However, prior attempts to produce a wet wipe with a textured surface have resulted in a wipe that cleans worse on one side of the wipe than the other side of the wipe. Consumers using products such as wet wipes do not want to make sure they are wiping with a certain side of the wipe when cleaning up bodily fluids or diapering an infant. As such, a need currently exists for an improved wet wipe having a textured surface that provides similar cleaning on both sides of the wipe.

### SUMMARY

A wet wipe that is formed from a nonwoven structure that comprises a matrix of at least one meltblown fibrous material and at least one secondary fibrous material is disclosed. A weight ratio of the at least one secondary fibrous material to the at least one meltblown fibrous material may be between about 40/60 to about 90/10. A basis weight of the fibrous nonwoven structure may be in a range of about 20 gsm to about 500 gsm. Additionally, the nonwoven structure has a first side with a textured surface having a three-dimensional texture that includes a plurality of peaks and valleys and a second side with a substantially planar surface. The nonwoven structure has about 150 to about 600 wt. % of a liquid solution based on the dry weight of the nonwoven structure to prepare a wet wipe. The difference in a cleaning pickup percentage between the first side and the second side of the wet wipe is less than 30%, more desirably less than 20%, and even more desirably less than 15%.

The meltblown fibers may be formed from a thermoplastic composition that contains at least one propylene/α-olefin copolymer having a propylene content of from about 60 mole % to about 99.5 mole % and an α-olefin content of from about 0.5 mole % to about 40 mole %. The copolymer further has a density of from about 0.87 to about 0.94 grams per cubic centimeter and a melt flow rate of from about 200 to about 6000 grams per 10 minutes, determined at 230° C. in accordance with ASTM Test Method D1238-E.

The matrix may be defined by a continuous region and a plurality of offset regions, the continuous region having a cross direction, a machine direction, and a thickness, the continuous region further comprising a planar first side extending in the cross direction and the machine direction and a second planar side opposite the first side, the first and second sides being separated by the thickness of the continuous region, the offset regions extend out from the first side, wherein the offset regions are positioned to define a plurality of first uninterrupted portions of the continuous regions, wherein the first uninterrupted portions of the continuous region do not underlie any offset regions, further wherein the first uninterrupted portions of the continuous region extend in a first direction in the plane of the first side, the first direction not intersecting any offset regions, and further wherein the width of the uninterrupted portions divided by the width of the offset regions is between about 0.3 and about 2, the widths measured perpendicular to the first direction in the plane of the first side, and even further wherein the continuous region extends completely under the offset regions. A method of forming a nonwoven structure is disclosed that comprises merging together a stream of a secondary fibrous material with a stream of meltblown fibers to form a composite stream. Thereafter, the composite stream is collected on a forming surface to form a coform nonwoven structure. The meltblown fibers are formed from a thermoplastic composition such as described above.

Other features and aspects of the present invention are described in more detail below.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended figures in which:

FIG. 1 is a schematic illustration of one embodiment of a method for forming the coform web of the present invention;

FIG. 2 is an illustration of certain features of the apparatus shown in FIG. 1;

FIG. 3 is a cross-sectional view of one embodiment of a textured coform nonwoven structure formed according to the present invention;

FIG. 4 is a plan view of a forming surface useful for forming the textured nonwoven structure of the present invention;

FIG. 5 is a top view of components of a test apparatus used to define cleaning pickup percentage defined herein;

FIG. 6 is a side view of components of the test apparatus in FIG. 5;

FIG. 7 is an end view of components of the test apparatus in FIG. 5;

FIG. 8 is an illustration of one of the components of the test apparatus in FIGS. 5; and

FIG. 9 is an illustration of another of the components of the test apparatus in FIG. 5.

Repeat use of reference characters in the present specification and drawings is intended to represent same or analogous features or elements of the invention.

### DETAILED DESCRIPTION OF REPRESENTATIVE EMBODIMENTS

### Definitions

As used herein the term “nonwoven structure” generally refers to a web having a structure of individual fibers or threads which are interlaid, but not in an identifiable manner as in a knitted fabric. Examples of suitable nonwoven fabrics or webs include, but are not limited to, meltblown webs, spunbond webs, bonded carded webs, airlaid webs, coform webs, hydraulically entangled webs, and so forth.

As used herein, the term “meltblown web” generally refers to a nonwoven structure that is formed by a process in which a molten thermoplastic material is extruded through a plurality of fine, usually circular, die capillaries as molten fibers into converging high velocity gas (e.g., air) streams that attenuate the fibers of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Butin et al., which is incorporated herein in its entirety by reference thereto for all purposes. Generally speaking, meltblown fibers may be microfibers that are substantially continuous or discontinuous, generally smaller than 10 micrometers in diameter, and generally tacky when deposited onto a collecting surface.

As used herein, the term “spunbond web” generally refers to a web containing small diameter substantially continuous fibers. The fibers are formed by extruding a molten thermoplastic material from a plurality of fine, usually circular, capillaries of a spinnerette with the diameter of the extruded fibers then being rapidly reduced as by, for example, eductive drawing and/or other well-known spunbonding mechanisms. The production of spunbond webs is described and illustrated, for example, in U.S. Pat. No. 4,340,563 to Appel et al.; U.S. Pat. No. 3,692,618 to Dorschner et al.; U.S. Pat. No. 3,802,817 to Matsuki et al.; U.S. Pat. No. 3,338,992 to Kinney; U.S. Pat. No. 3,341,394 to Kinney; U.S. Pat. No. 3,502,763 to Hartman; U.S. Pat. No. 3,502,538 to Levy; U.S. Pat. No. 3,542,615 to Dobo et al.; and U.S. Pat. No. 5,382,400 to Pike et al., which are incorporated herein in their entirety by reference thereto for all purposes. Spunbond fibers are generally not tacky when they are deposited onto a collecting surface. Spunbond fibers may sometimes have diameters less than about 40 micrometers, and are often between about 5 to about 20 micrometers.

### DETAILED DESCRIPTION

Reference now will be made in detail to various embodiments of the invention, one or more examples of which are set forth below. Each example is provided by way of explanation, not limitation of the invention. In fact, it will be apparent to those skilled in the art that various modifications and variations may be made in the present invention without departing from the scope or spirit of the invention. For instance, features illustrated or described as part of one embodiment, may be used on another embodiment to yield a still further embodiment. Thus, it is intended that the present invention cover such modifications and variations.

Generally, a wet wipe comprising a fibrous nonwoven structure having at least one meltblown fibrous material and at least one secondary fibrous material is disclosed. The fibrous nonwoven structure may have a weight ratio of the at least one secondary fibrous material to the at least one meltblown fibrous material in between about 40/60 to about 90/10. Additionally, a basis weight of the fibrous nonwoven structure is in a range of about 20 gsm to about 500 gsm. Additionally, the nonwoven structure is manufactured to have a first side with a textured surface and a second side with a substantially planar surface.

To prepare a wet wipe, about 150 to about 600 wt. % of a liquid solution based on the dry weight of the nonwoven structure is added. A consumer is able to use either the textured side or the substantially planar side to wipe a surface, and remove some unwanted material from the surface. Surprisingly, the difference in a wiping pick-up efficiency percentage between a wipe having a first side with a textured surface and a second side with a substantially planar surface manufactured as described herein is less than 30%. More desirably, the difference in a wiping pick-up efficiency percentage between a wipe with a textured surface and a second side with a substantially planar surface manufactured as described herein is less than 20%. Even more desirably, the difference in a wiping pick-up efficiency percentage between a wipe with a textured surface and a second side with a substantially planar surface manufactured as described herein is less than 10%.

The basesheet can be made from a variety of materials including meltblown materials, coform materials, air-laid materials, bonded-carded web materials, hydroentangled materials, spunbond materials and the like, and can comprise synthetic or natural fibers.

The fibrous nonwoven structure may be used as a wet wipe, and in particular for baby wipes. Different physical characteristics of the fibrous nonwoven structure may be varied to provide the best quality wet wipe. For example, formation, diameter of meltblown fibers, the amount of lint, opacity and other physical characteristics of the fibrous nonwoven structure may be altered to provide a useful wet wipe for consumers.

Typically, the fibrous nonwoven structure is a combination of meltblown fibrous materials and secondary fibrous materials, the relative percentages of the meltblown fibrous materials and secondary fibrous materials in the layer can vary over a wide range depending on the desired characteristics of the fibrous nonwoven structure. For example, fibrous nonwoven structures can have from about 20 to 60 wt. % of meltblown fibrous materials and from about 40 to 80 wt. % of secondary fibers. Desirably, the weight ratio of meltblown fibrous materials to secondary fibers can be from about 20/80 to about 60/40. More desirably, the weight ratio of meltblown fibrous materials fibers to secondary fibers can be from 25/75 to about 40/60.

Generally speaking, the overall basis weight of the coform nonwoven structure is from about 10 gsm to about 500 gsm, and more particularly from about 17 gsm to about 200 gsm, and still more particularly from about 25 gsm to about 150 gsm. Such basis weight of the fibrous nonwoven structure may also vary depending upon the desired end use of the fibrous nonwoven structure. For example, a suitable fibrous nonwoven structure for wiping the skin may define a basis weight of from about 30 to about 80 gsm and desirably about 45 to 75 gsm. The basis weight (in grams per square meter, g/m² or gsm) is calculated by dividing the dry weight (in grams) by the area (in square meters).

One approach is to mix meltblown fibrous materials with one or more types of secondary fibrous materials and/or particulates. The mixtures are collected in the form of fibrous nonwoven structures which may be bonded or treated to provide coherent nonwoven materials that take advantage of at least some of the properties of each component. These mixtures are referred to as “coform” materials because they are formed by combining two or more materials in the forming step into a single structure.

A nonwoven fabric-like material having a unique combination of strength and absorbency comprising an air-formed mixture of thermoplastic polymer microfibers and a multiplicity of individualized secondary fibrous materials disposed throughout the mixture of microfibers and engaging at least some of the microfibers to space the microfibers apart from each other is desirable.

Meltblown fibrous materials suitable for use in the fibrous nonwoven structure include polyolefins, for example, polyethylene, polypropylene, polybutylene and the like, polyamides, olefin copolymers and polyesters. In accordance with a particularly desirable embodiment, the meltblown fibrous materials used in the formation of the fibrous nonwoven structure are polypropylene. The meltblown fibers may be monocomponent or multicomponent. Monocomponent fibers are generally formed from a polymer or blend of polymers extruded from a single extruder. Multicomponent fibers are generally formed from two or more polymers (e.g., bicomponent fibers) extruded from separate extruders. The polymers may be arranged in substantially constantly positioned distinct zones across the cross-section of the fibers. The components may be arranged in any desired configuration, such as sheath-core, side-by-side, pie, island-in-the-sea, three island, bull's eye, or various other arrangements known in the art. Various methods for forming multicomponent fibers are described in U.S. Pat. No. 4,789,592 to Taniguchi et al.; U.S. Pat. No. 5,336,552 to Strack et al.; U.S. Pat. No. 5,108,820 to Kaneko et al.; U.S. Pat. No. 4,795,668 to Kruege et al.; U.S. Pat. No. 5,382,400 to Pike et al.; U.S. Pat. No. 5,336,552 to Strack et al.; and U.S. Pat. No. 6,200,669 to Marmon et al., which are incorporated herein in their entirety by reference thereto for all purposes. Multicomponent fibers having various irregular shapes may also be formed, such as described in U.S. Pat. No. 5,277,976 to Hogle et al.; U.S. Pat. No. 5,162,074 to Hills; U.S. Pat. No. 5,466,410 to Hills; U.S. Pat. No. 5,069,970 to Largman et al.; and U.S. Pat. No. 5,057,368 to Largman et al., which are incorporated herein in their entirety by reference thereto for all purposes.

At least a portion of the meltblown fibers may be formed from a thermoplastic composition that contains at least one propylene/α-olefin copolymer of a certain monomer content, density, melt flow rate, etc. The selection of a specific type of propylene/α-olefin copolymer provides the resulting composition with improved thermal properties for forming a coform web. For example, the thermoplastic composition crystallizes at a relatively slow rate, thereby allowing the fibers to remain slightly tacky during formation. This tackiness may provide a variety of benefits, such as enhancing the ability of the meltblown fibers to adhere to the secondary fibrous material during web formation. Due in part to its enhanced bonding capacity, a lower amount of meltblown fibers may also be employed than previously thought needed to form a coherent and self-supporting coform structure. For example, the meltblown fibers may constitute from about 2 wt. % to about 40 wt. %, in some embodiments from 4 wt. % to about 30 wt. %, and in some embodiments, from about 5 wt. % to about 20 wt. % of the coform web. Likewise, the secondary fibrous material may constitute from about 60 wt. % to about 98 wt. %, in some embodiments from 70 wt. % to about 96 wt. %, and in some embodiments, from about 80 wt. % to about 95 wt. % of the coform web.

The thermoplastic composition contains at least one copolymer of propylene and an α-olefin, such as a C₂₋₂₀ α-olefin, C₂₋₁₂ α-olefin, or C₂₋₈ α-olefin. Suitable α-olefins may be linear or branched (e.g., one or more C₁₋₃ alkyl branches, or an aryl group). Specific examples include ethylene, butene; 3-methyl-1-butene; 3,3-dimethyl-1-butene; pentene; pentene with one or more methyl, ethyl or propyl substituents; hexene with one or more methyl, ethyl or propyl substituents; heptene with one or more methyl, ethyl or propyl substituents; octene with one or more methyl, ethyl or propyl substituents; nonene with one or more methyl, ethyl or propyl substituents; ethyl, methyl or dimethyl-substituted decene; dodecene; styrene; and so forth. Particularly desired α-olefin comonomers are ethylene, butene (e.g., 1-butene), hexene, and octene (e.g., 1-octene or 2-octene). The propylene content of such copolymers may be from about 60 mole % to about 99.5 mole %, in some embodiments from about 80 mole % to about 99 mole %, and in some embodiments, from about 85 mole % to about 98 mole %. The α-olefin content may likewise range from about 0.5 mole % to about 40 mole %, in some embodiments from about 1 mole % to about 20 mole %, and in some embodiments, from about 2 mole % to about 15 mole %. The distribution of the α-olefin comonomer is typically random and uniform among the differing molecular weight fractions forming the propylene copolymer.

The density of the propylene/α-olefin copolymer may be a function of both the length and amount of the α-olefin. That is, the greater the length of the α-olefin and the greater the amount of α-olefin present, the lower the density of the copolymer. Generally speaking, copolymers with a higher density are better able to retain a three-dimensional structure, while those with a lower density possess better elastomeric properties. Thus, to achieve an optimum balance between texture and stretchability, the propylene/α-olefin copolymer is normally selected to have a density of about 0.87 grams per cubic centimeter (g/cm³) to about 0.94 g/cm³, in some embodiments from about 0.88 to about 0.92 g/cm³, and in some embodiments, from about 0.88 g/cm³ to about 0.90 g/cm³.

Any of a variety of known techniques may generally be employed to form the propylene/α-olefin copolymer used in the meltblown fibers. For instance, olefin polymers may be formed using a free radical or a coordination catalyst (e.g., Ziegler-Natta). Preferably, the copolymer is formed from a single-site coordination catalyst, such as a metallocene catalyst. Such a catalyst system produces propylene copolymers in which the co-monomer is randomly distributed within a molecular chain and uniformly distributed across the different molecular weight fractions. Metallocene-catalyzed propylene copolymers are described, for instance, in U.S. Pat. No. 7,105,609 to Datta et al.; U.S. Pat. No. 6,500,563 to Datta et al.; U.S. Pat. No. 5,539,056 to Yang et al.; and U.S. Pat. No. 5,596,052 to Resconi et al., which are incorporated herein in their entirety by reference thereto for all purposes. Examples of metallocene catalysts include bis(n-butylcyclopentadienyl)titanium dichloride, bis(n-butylcyclopentadienyl)zirconium dichloride, bis(cyclopentadienyl)scandium chloride, bis(indenyl)zirconium dichloride, bis(methylcyclopentadienyl)titanium dichloride, bis(methylcyclopentadienyl)zirconium dichloride, cobaltocene, cyclopentadienyltitanium trichloride, ferrocene, hafnocene dichloride, isopropyl(cyclopentadienyl,-1-flourenyl)zirconium dichloride, molybdocene dichloride, nickelocene, niobocene dichloride, ruthenocene, titanocene dichloride, zirconocene chloride hydride, zirconocene dichloride, and so forth. Polymers made using metallocene catalysts typically have a narrow molecular weight range. For instance, metallocene-catalyzed polymers may have polydispersity numbers (M_{w}/Mₙ) of below 4, controlled short chain branching distribution, and controlled tacticity.

In some embodiments the propylene/α-olefin copolymer constitutes about 50 wt. % or more, in some embodiments about from 60 wt. % or more, and in some embodiments, about 75 wt. % or more of the thermoplastic composition used to form the meltblown fibers. In other embodiments the propylene/α-olefin copolymer constitutes at least about 1 wt. % and less than about 49 wt. %, in some embodiments from at least about 1% and less than about 45 wt. %, in some embodiments from at least about 5% and less than about 45 wt. %, and in some embodiments, from at least about 5 wt. % and less than about 30 wt. % of the thermoplastic composition used to form the meltblown fibers. Of course, other thermoplastic polymers may also be used to form the meltblown fibers so long as they do not adversely affect the desired properties of the composite. For example, the meltblown fibers may contain other polyolefins (e.g., polypropylene, polyethylene, etc.), polyesters, polyurethanes, polyamides, block copolymers, and so forth. In one embodiment, the meltblown fibers may contain an additional propylene polymer, such as homopolypropylene or a copolymer of propylene. The additional propylene polymer may, for instance, be formed from a substantially isotactic polypropylene homopolymer or a copolymer containing equal to or less than about 14 wt. % of other monomer, i.e., at least about 86% by weight propylene. Such a polypropylene may be present in the form of a graft, random, or block copolymer and may be predominantly crystalline in that it has a sharp melting point above about 110° C., in some embodiments about above 115° C., and in some embodiments, above about 130° C. Examples of such additional polypropylenes are described in U.S. Pat. No. 6,992,159 to Datta et al., which is incorporated herein in its entirety by reference thereto for all purposes.

In some embodiments, additional polymer(s) may constitute from about 0.1 wt. % to about 50 wt. %, in some embodiments from about 0.5 wt. % to about 40 wt. %, and in some embodiments, from about 1 wt. % to about 30 wt. % of the thermoplastic composition. Likewise, the above-described propylene/α-olefin copolymer may constitute from about 50 wt. % to about 99.9 wt. %, in some embodiments from about 60 wt. % to about 99.5 wt. %, and in some embodiments, from about 75 wt. % to about 99 wt. % of the thermoplastic composition.

In other embodiments, additional polymer(s) may constitute from greater than about 50 wt. %, in some embodiments from about 50 wt. % to about 99 wt. %, in some embodiments from about 55 wt. % to about 99 wt. %, in some embodiments from about 55 wt. % to about 95 wt. %, and in some embodiments from about 70 wt. % to about 95 wt. %. Likewise, the above described propylene/α-olefin copolymer may constitute from less than about 49 wt. %, in some embodiments from about 1 wt. % to about 49 wt. %, in some embodiments from about 1 wt. % to about 45 wt. %, in some embodiments from about 5 wt. % to about 45 wt. %, and in some embodiments, from about 5 wt. % to about 30 wt. % of the thermoplastic composition.

The thermoplastic composition used to form the meltblown fibers may also contain other additives as is known in the art, such as melt stabilizers, processing stabilizers, heat stabilizers, light stabilizers, antioxidants, heat aging stabilizers, whitening agents, etc. Phosphite stabilizers (e.g., IRGAFOS available from Ciba Specialty Chemicals of Tarrytown, N.Y. and DOVERPHOS available from Dover Chemical Corp. of Dover, Ohio) are exemplary melt stabilizers. In addition, hindered amine stabilizers (e.g., CHIMASSORB available from Ciba Specialty Chemicals) are exemplary heat and light stabilizers. Further, hindered phenols are commonly used as an antioxidant. Some suitable hindered phenols include those available from Ciba Specialty Chemicals under the trade name “Irganox®”, such as Irganox® 1076, 1010, or E 201. When employed, such additives (e.g., antioxidant, stabilizer, etc.) may each be present in an amount from about 0.001 wt. % to about 15 wt. %, in some embodiments, from about 0.005 wt. % to about 10 wt. %, and in some embodiments, from 0.01 wt. % to about 5 wt. % of the thermoplastic composition used to form the meltblown fibers.

Through the selection of certain polymers and their content, the resulting thermoplastic composition may possess thermal properties superior to polypropylene homopolymers conventionally employed in meltblown webs. For example, the thermoplastic composition is generally more amorphous in nature than polypropylene homopolymers conventionally employed in meltblown webs. For this reason, the rate of crystallization of the thermoplastic composition is slower, as measured by its “crystallization half-time”, i.e., the time required for one-half of the material to become crystalline. For example, the thermoplastic composition typically has a crystallization half-time of greater than about 5 minutes, in some embodiments from about 5.25 minutes to about 20 minutes, and in some embodiments, from about 5.5 minutes to about 12 minutes, determined at a temperature of 125° C. To the contrary, conventional polypropylene homopolymers often have a crystallization half-time of 5 minutes or less. Further, the thermoplastic composition may have a melting temperature (“Tₘ”) of from about 100° C. to about 250° C., in some embodiments from about 110° C. to about 200° C., and in some embodiments, from about 140° C. to about 180° C. The thermoplastic composition may also have a crystallization temperature (“T_{c}”) (determined at a cooling rate of 10° C./min) of from about 50° C. to about 150° C., in some embodiments from about 80° C. to about 140° C., and in some embodiments, from about 100° C. to about 120° C. The crystallization half-time, melting temperature, and crystallization temperature may be determined using differential scanning calorimetry (“DSC”) as is well known to those skilled in the art and described in more detail below.

The melt flow rate of the thermoplastic composition may also be selected within a certain range to optimize the properties of the resulting meltblown fibers. The melt flow rate is the weight of a polymer (in grams) that may be forced through an extrusion rheometer orifice (0.0825-inch diameter) when subjected to a force of 2160 grams in 10 minutes at 230° C. Generally speaking, the melt flow rate is high enough to improve melt processability, but not so high as to adversely interfere with the binding properties of the fibers to the secondary fibrous material. Thus, in most embodiments, the thermoplastic composition has a melt flow rate of from about 200 to about 6000 grams per 10 minutes, in some embodiments from about 300 to about 3000 grams per 10 minutes, and in some embodiments, from about 400 to about 1500 grams per 10 minutes, measured in accordance with ASTM Test Method D1238-E.

The fibrous nonwoven structure also includes one or more types of secondary fibrous materials to form the nonwoven structure. Any secondary fibrous material may generally be employed in the coform nonwoven structure, such as absorbent fibers, particles, etc. In one embodiment, the secondary fibrous material includes fibers formed by a variety of pulping processes, such as kraft pulp, sulfite pulp, thermomechanical pulp, etc. The pulp fibers may include softwood fibers having an average fiber length of greater than 1 mm and particularly from about 2 to 5 mm based on a length-weighted average. Such softwood fibers can include, but are not limited to, northern softwood, southern softwood, redwood, red cedar, hemlock, pine (e.g., southern pines), spruce (e.g., black spruce), combinations thereof, and so forth. Exemplary commercially available pulp fibers suitable include those available from Weyerhaeuser Co. of Federal Way, Wash. under the designation “Weyco CF-405.” Hardwood fibers, such as eucalyptus, maple, birch, aspen, and so forth, can also be used. In certain instances, eucalyptus fibers may be particularly desired to increase the softness of the web. Eucalyptus fibers can also enhance the brightness, increase the opacity, and change the pore structure of the web to increase its wicking ability. Moreover, if desired, secondary fibers obtained from recycled materials may be used, such as fiber pulp from sources such as, for example, newsprint, reclaimed paperboard, and office waste. Further, other natural fibers can also be used, such as abaca, sabai grass, milkweed floss, pineapple leaf, and so forth. In addition, in some instances, synthetic fibers can also be utilized.

Besides or in conjunction with pulp fibers, the secondary fibrous material may also include a superabsorbent that is in the form of fibers, particles, gels, etc. Generally speaking, superabsorbents are water-swellable materials capable of absorbing at least about 20 times its weight and, in some cases, at least about 30 times its weight in an aqueous solution containing 0.9 wt. % sodium chloride. The superabsorbent may be formed from natural, synthetic and modified natural polymers and materials. Examples of synthetic superabsorbent polymers include the alkali metal and ammonium salts of poly(acrylic acid) and poly(methacrylic acid), poly(acrylamides), poly(vinyl ethers), maleic anhydride copolymers with vinyl ethers and alpha-olefins, poly(vinyl pyrrolidone), poly(vinylmorpholinone), poly(vinyl alcohol), and mixtures and copolymers thereof. Further, superabsorbents include natural and modified natural polymers, such as hydrolyzed acrylonitrile-grafted starch, acrylic acid grafted starch, methyl cellulose, chitosan, carboxymethyl cellulose, hydroxypropyl cellulose, and the natural gums, such as alginates, xanthan gum, locust bean gum and so forth. Mixtures of natural and wholly or partially synthetic superabsorbent polymers may also be useful. Particularly suitable superabsorbent polymers are HYSORB 8800AD (BASF of Charlotte, N.C. and FAVOR SXM 9300 (available from Evonik Stockhausen of Greensboro, N.C.).

Wood pulp fibers are particularly preferred as a secondary fibrous material because of low cost, high absorbency and retention of satisfactory tactile properties.

The secondary fibrous materials are interconnected by and held captive within the microfibers by mechanical entanglement of the microfibers with the secondary fibrous materials, the mechanical entanglement and interconnection of the microfibers and secondary fibrous materials alone forming a coherent integrated fiber structure. The coherent integrated fiber structure may be formed by the microfibers and secondary fibrous materials without any adhesive, molecular or hydrogen bonds between the two different types of fibers. The material is formed by initially forming a primary air stream containing the meltblown microfibers, forming a secondary air stream containing the secondary fibrous materials, merging the primary and secondary streams under turbulent conditions to form an integrated air stream containing a thorough mixture of the microfibers and secondary fibrous materials, and then directing the integrated air stream onto a forming surface to air form the fabric-like material. The microfibers are in a soft nascent condition at an elevated temperature when they are turbulently mixed with the pulp fibers in air.

In addition to enhancing the bonding capacity of the meltblown fibers, the thermoplastic composition may also impart other benefits to the resulting coform structure. In certain embodiments, for example, the coform web may be imparted with texture using a three-dimensional forming surface. In such embodiments, the relatively slow rate of crystallization of the meltblown fibers may increase their ability to conform to the contours of the three-dimensional forming surface. Once the fibers crystallize, however, the meltblown fibers may achieve a degree of stiffness similar to conventional polypropylene, thereby allowing them to retain their three-dimensional shape and form a highly textured surface on the coform web.

In certain embodiments, the wipe is a “wet” or “premoistened” wipe in that it contains a liquid solution for cleaning, disinfecting, sanitizing, etc. The particular liquid solutions are not critical and are described in more detail in U.S. Pat. No. 6,440,437 to Krzysik et al.; U.S. Pat. No. 6,028,018 to Amundson et al.; U.S. Pat. No. 5,888,524 to Cole; U.S. Pat. No. 5,667,635 to Win et al.; and U.S. Pat. No. 5,540,332 to Kopacz et al., which are incorporated herein in their entirety by reference thereto for all purposes. The amount of the liquid solution employed may depend upon the type of wipe material utilized, the type of container used to store the wipes, the nature of the cleaning formulation, and the desired end use of the wipes. Generally, each wipe contains from about 150 to about 600 wt. % and desirably from about 300 to about 500 wt. % of a liquid solution based on the dry weight of the nonwoven structure.

The coform web is manufactured by a process in which at least one meltblown die head (e.g., two) is arranged near a chute through which the secondary fibrous material is added while the web forms. Some examples of such coform techniques are disclosed in U.S. Pat. No. 4,100,324 to Anderson et al.; U.S. Pat. No. 5,350,624 to Georger et al.; and U.S. Pat. No. 5,508,102 to Georger et al., as well as U.S. Patent Application Publication Nos. 2003/0200991 to Keck et al. and 2007/0049153 to Dunbar et al., all of which are incorporated herein in their entirety by reference thereto for all purposes.

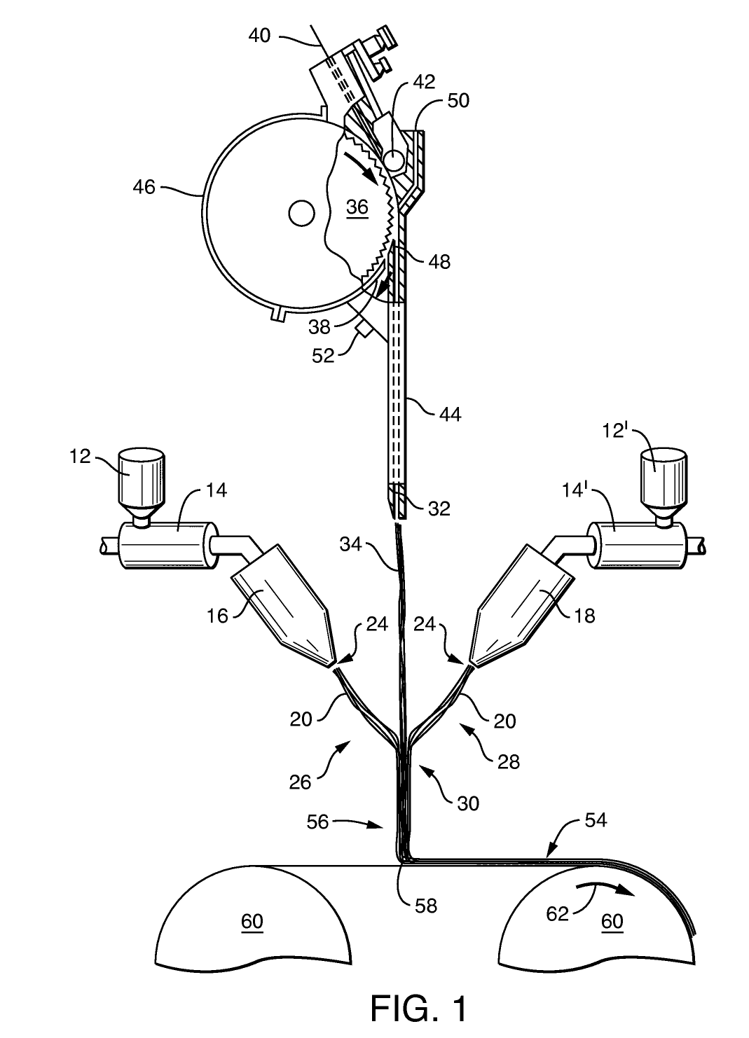

Referring to FIG. 1, for example, one embodiment of an apparatus is shown for forming a coform web. In this embodiment, the apparatus includes a pellet hopper 12 or 12′ of an extruder 14 or 14′, respectively, into which a propylene/α-olefin thermoplastic composition may be introduced. The extruders 14 and 14′ each have an extrusion screw (not shown), which is driven by a conventional drive motor (not shown). As the polymer advances through the extruders 14 and 14′, it is progressively heated to a molten state due to rotation of the extrusion screw by the drive motor. Heating may be accomplished in a plurality of discrete steps with its temperature being gradually elevated as it advances through discrete heating zones of the extruders 14 and 14′ toward two meltblowing dies 16 and 18, respectively. The meltblowing dies 16 and 18 may be yet another heating zone where the temperature of the thermoplastic resin is maintained at an elevated level for extrusion.

When two or more meltblowing die heads are used, such as described above, it should be understood that the fibers produced from the individual die heads may be different types of fibers. That is, one or more of the size, shape, or polymeric composition may differ, and furthermore the fibers may be monocomponent or multicomponent fibers. For example, larger fibers may be produced by the first meltblowing die head, such as those having an average diameter of about 10 micrometers or more, in some embodiments about 15 micrometers or more, and in some embodiments, from about 20 to about 50 micrometers, while smaller fibers may be produced by the second die head, such as those having an average diameter of about 10 micrometers or less, in some embodiments about 7 micrometers or less, and in some embodiments, from about 2 to about 6 micrometers. In addition, it may be desirable that each die head extrude approximately the same amount of polymer such that the relative percentage of the basis weight of the coform nonwoven structure material resulting from each meltblowing die head is substantially the same. Alternatively, it may also be desirable to have the relative basis weight production skewed, such that one die head or the other is responsible for the majority of the coform web in terms of basis weight. As a specific example, for a meltblown fibrous nonwoven structure material having a basis weight of 1 ounce per square yard or “osy” (34 grams per square meter or “gsm”), it may be desirable for the first meltblowing die head to produce about 30 percent of the basis weight of the meltblown fibrous nonwoven structure material, while one or more subsequent meltblowing die heads produce the remainder 70 percent of the basis weight of the meltblown fibrous nonwoven structure material. Generally speaking, the overall basis weight of the coform nonwoven structure is from about 10 gsm to about 500 gsm, and more particularly from about 17 gsm to about 200 gsm, and still more particularly from about 25 gsm to about 150 gsm.

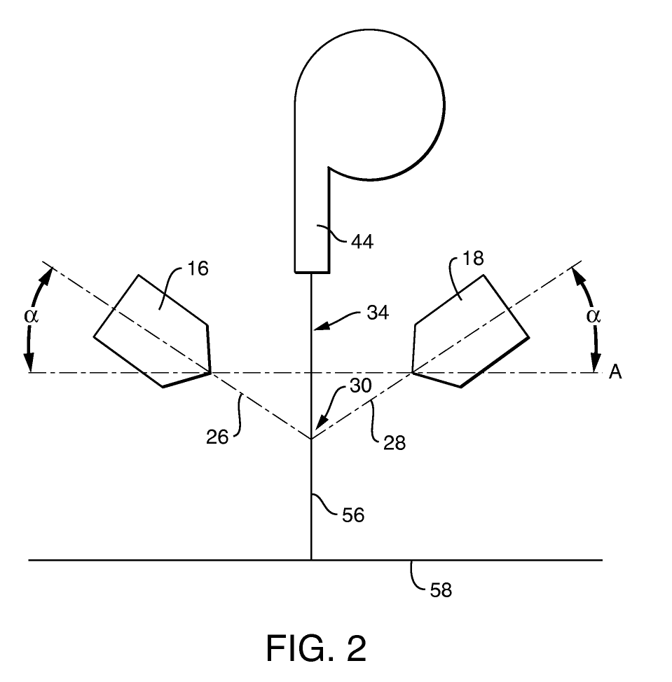

Each meltblowing die 16 and 18 is configured so that two streams of attenuating gas per die converge to form a single stream of gas which entrains and attenuates molten threads 20 as they exit small holes or orifices 24 in each meltblowing die. The molten threads 20 are formed into fibers or, depending upon the degree of attenuation, microfibers, of a small diameter which is usually less than the diameter of the orifices 24. Thus, each meltblowing die 16 and 18 has a corresponding single stream of gas 26 and 28 containing entrained thermoplastic polymer fibers. The gas streams 26 and 28 containing polymer fibers are aligned to converge at an impingement zone 30. Typically, the meltblowing die heads 16 and 18 are arranged at a certain angle with respect to the forming surface, such as described in U.S. Pat. Nos. 5,508,102 and 5,350,624 to Georger et al. Referring to FIG. 2, for example, the meltblown dies 16 and 18 may be oriented at an angle a as measured from a plane “A” tangent to the two dies 16 and 18. As shown, the plane “A” is generally parallel to the forming surface 58 (FIG. 1). Typically, each die 16 and 18 is set at an angle ranging from about 30 to about 75°, in some embodiments from about 35° to about 60°, and in some embodiments from about 45° to about 55°. The dies 16 and 18 may be oriented at the same or different angles. In fact, the texture of the coform web may actually be enhanced by orienting one die at an angle different than another die.

Referring again to FIG. 1, absorbent fibers 32 (e.g., pulp fibers) are added to the two streams 26 and 28 of thermoplastic polymer fibers 20 and 21, respectively, and at the impingement zone 30. Introduction of the absorbent fibers 32 into the two streams 26 and 28 of thermoplastic polymer fibers 20 and 21, respectively, is designed to produce a graduated distribution of absorbent fibers 32 within the combined streams 26 and 28 of thermoplastic polymer fibers. This may be accomplished by merging a secondary gas stream 34 containing the absorbent fibers 32 between the two streams 26 and 28 of thermoplastic polymer fibers 20 and 21 so that all three gas streams converge in a controlled manner. Because they remain relatively tacky and semi-molten after formation, the meltblown fibers 20 and 21 may simultaneously adhere and entangle with the absorbent fibers 32 upon contact therewith to form a coherent nonwoven structure.

To accomplish the merger of the fibers, any conventional equipment may be employed, such as a picker roll 36 arrangement having a plurality of teeth 38 adapted to separate a mat or batt 40 of absorbent fibers into the individual absorbent fibers. When employed, the sheets or mats 40 of fibers 32 are fed to the picker roll 36 by a roller arrangement 42. After the teeth 38 of the picker roll 36 have separated the mat of fibers into separate absorbent fibers 32, the individual fibers are conveyed toward the stream of thermoplastic polymer fibers through a nozzle 44. A housing 46 encloses the picker roll 36 and provides a passageway or gap 48 between the housing 46 and the surface of the teeth 38 of the picker roll 36. A gas, for example, air, is supplied to the passageway or gap 46 between the surface of the picker roll 36 and the housing 48 by way of a gas duct 50. The gas duct 50 may enter the passageway or gap 46 at the junction 52 of the nozzle 44 and the gap 48. The gas is supplied in sufficient quantity to serve as a medium for conveying the absorbent fibers 32 through the nozzle 44. The gas supplied from the duct 50 also serves as an aid in removing the absorbent fibers 32 from the teeth 38 of the picker roll 36. The gas may be supplied by any conventional arrangement such as, for example, an air blower (not shown). It is contemplated that additives and/or other materials may be added to or entrained in the gas stream to treat the absorbent fibers. The individual absorbent fibers 32 are typically conveyed through the nozzle 44 at about the velocity at which the absorbent fibers 32 leave the teeth 38 of the picker roll 36. In other words, the absorbent fibers 32, upon leaving the teeth 38 of the picker roll 36 and entering the nozzle 44, generally maintain their velocity in both magnitude and direction from the point where they left the teeth 38 of the picker roll 36. Such an arrangement is discussed in more detail in U.S. Pat. No. 4,100,324 to Anderson et al.

If desired, the velocity of the secondary gas stream 34 may be adjusted to achieve coform structures of different properties. For example, when the velocity of the secondary gas stream is adjusted so that it is greater than the velocity of each stream 26 and 28 of thermoplastic polymer fibers 20 and 21 upon contact at the impingement zone 30, the absorbent fibers 32 are incorporated in the coform nonwoven structure in a gradient structure. That is, the absorbent fibers 32 have a higher concentration between the outer surfaces of the coform nonwoven structure than at the outer surfaces. On the other hand, when the velocity of the secondary gas stream 34 is less than the velocity of each stream 26 and 28 of thermoplastic polymer fibers 20 and 21 upon contact at the impingement zone 30, the absorbent fibers 32 are incorporated in the coform nonwoven structure in a substantially homogenous fashion. That is, the concentration of the absorbent fibers is substantially the same throughout the coform nonwoven structure. This is because the low-speed stream of absorbent fibers is drawn into a high-speed stream of thermoplastic polymer fibers to enhance turbulent mixing which results in a consistent distribution of the absorbent fibers.

To convert the composite stream 56 of thermoplastic polymer fibers 20, 21 and absorbent fibers 32 into a coform nonwoven structure 54, a collecting device is located in the path of the composite stream 56. The collecting device may be a forming surface 58 (e.g., belt, drum, wire, fabric, etc.) driven by rollers 60 and that is rotating as indicated by the arrow 62 in FIG. 1. The merged streams of thermoplastic polymer fibers and absorbent fibers are collected as a coherent matrix of fibers on the surface of the forming surface 58 to form the coform nonwoven structure 54. If desired, a vacuum box (not shown) may be employed to assist in drawing the near molten meltblown fibers onto the forming surface 58. The resulting textured coform structure 54 is coherent and may be removed from the forming surface 58 as a self-supporting nonwoven material.

It should be understood that the present invention is by no means limited to the above-described embodiments. In an alternative embodiment, for example, first and second meltblowing die heads may be employed that extend substantially across a forming surface in a direction that is substantially transverse to the direction of movement of the forming surface. The die heads may likewise be arranged in a substantially vertical disposition, i.e., perpendicular to the forming surface, so that the thus-produced meltblown fibers are blown directly down onto the forming surface. Such a configuration is well known in the art and described in more detail in, for instance, U.S. Patent Application Publication No. 2007/0049153 to Dunbar et al. Furthermore, although the above-described embodiments employ multiple meltblowing die heads to produce fibers of differing sizes, a single die head may also be employed. An example of such a process is described, for instance, in U.S. Patent Application Publication No. 2005/0136781 to Lassig et al., which is incorporated herein in its entirety by reference thereto for all purposes.

As indicated above, it is desired in certain cases to form a coform web that is textured. Referring again to FIG. 1, for example, a forming surface 58 that is foraminous in nature so that the fibers may be drawn through the openings of the surface and form dimensional cloth-like tufts projecting from the surfaces of the material that correspond to the openings in the forming surface 58. The foraminous surface may be provided by any material that provides sufficient openings for penetration by some of the fibers, such as a highly permeable forming belt.

Desirably, the forming surface is a perforated polyurethane topped belt, wherein the belt ranges from 2.6 mm to 5.9 mm thick. The patterns were cut into the belts with dies or water cutting. Another method includes using foam or rubber sheets with the same patterns cut in them. The particular choice will depend on the desired peak size, shape, depth, surface tuft “density” (that is, the number of peaks or tufts per unit area), etc. The sheets may range from 1 mm to 18 mm in pocket depth. Other examples of forming surfaces to create texture on wipes include wire weave geometry and processing conditions used to alter the texture or tufts of the material. Exemplary of these wire weave geometry forming surfaces is the forming wire FORMTECH™ 6 manufactured by Albany International Co. of Albany, N.Y. Such a wire has a “mesh count” of about six strands by six strands per square inch (about 2.4 by 2.4 strands per square centimeter), i.e., resulting in about 36 foramina or “holes” per square inch (about 5.6 per square centimeter), and therefore capable of forming about 36 tufts or peaks in the material per square inch (about 5.6 peaks per square centimeter). The FORMTECH™ 6 wire also has a warp diameter of about 1 millimeter polyester, a shute diameter of about 1.07 millimeters polyester, a nominal air permeability of approximately 41.8 m³/min (1475 ft³/min), a nominal caliper of about 0.2 centimeters (0.08 inch) and an open area of approximately 51%. Another exemplary forming surface available from the Albany International Co. is the forming wire FORMTECH™ 10, which has a mesh count of about 10 strands by 10 strands per square inch (about 4 by 4 strands per square centimeter), i.e., resulting in about 100 foramina or “holes” per square inch (about 15.5 per square centimeter), and therefore capable of forming about 100 tufts or peaks per square inch (about 15.5 peaks per square centimeter) in the material. Still another suitable forming wire is FORMTECH™ 8, which has an open area of 47% and is also available from Albany International Co. Of course, other forming wires and surfaces (e.g., drums, plates, etc.) may be employed. Also, surface variations may include, but are not limited to, alternate weave patterns, alternate strand dimensions, release coatings (e.g., silicones, fluorochemicals, etc.), static dissipation treatments, and the like. Still other suitable foraminous surfaces that may be employed are described in U.S. Patent Application Publication No. 2007/0049153 to Dunbar et al.

The tufts formed by the meltblown fibers disclosed herein are better able to retain the desired shape and surface contour and provide lower differentiation in cleaning between the textured and non-textured side of the wipe. It is believed that because the meltblown fibers crystallize at a relatively slow rate, they are soft upon deposition onto the forming surface, which allows them to drape over and conform to the contours of the surface. After the fibers crystallize, they are then able to hold the shape and form tufts. The size and shape of the resulting tufts depends upon the type of forming surface used, the types of fibers deposited thereon, the volume of below wire air vacuum used to draw the fibers onto and into the forming surface, and other related factors. For example, the tufts may project from the surface of the material in the range of about 0.25 millimeters to at least about 9 millimeters, and in some embodiments, from about 0.5 millimeters to about 3 millimeters. Generally speaking, the tufts are filled with fibers and thus have desirable resiliency useful for wiping and scrubbing.

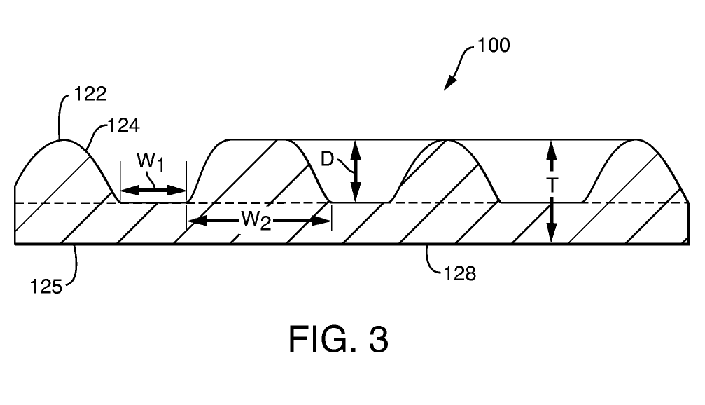

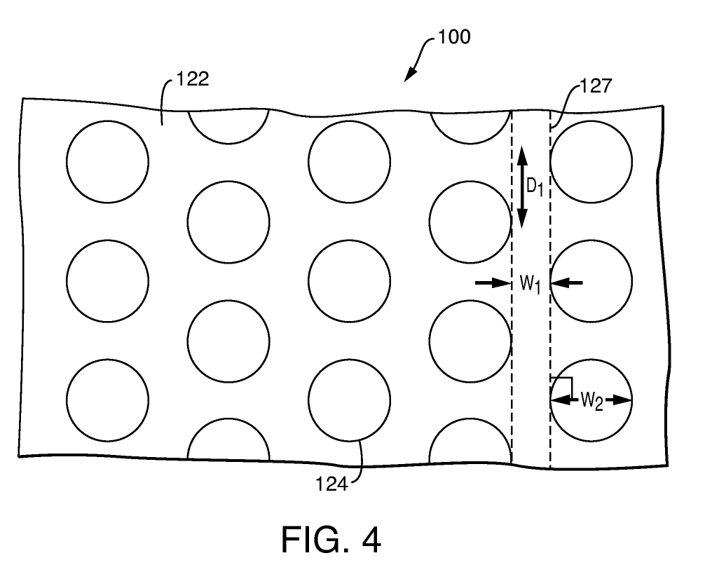

Referring to FIGS. 3 and 4, a textured coform web 100 has a first exterior surface 122 and a second exterior surface 128. At least one of the exterior surfaces has a three-dimensional surface texture. In FIG. 3, for instance, the first exterior surface 122 has a three-dimensional surface texture that includes tufts, peaks, or offset regions 124 extending upwardly from a continuous region 125 that extends continuously in the machine and cross directions of the coform web 100. The continuous region 125 may have a thickness (T-D) ranging from about 0.01 millimeters to about 5 millimeters, desirably ranging from about 0.02 to about 4 millimeters, and more desirably ranging from about 0.03 to about 3 millimeters. One indication of the magnitude of three-dimensionality in the textured exterior surface(s) of the coform web is the peak to valley ratio, which is calculated as the ratio of the overall thickness “T” divided by the valley depth “D.” When textured, the coform web typically has a peak to valley ratio of about 5 or less, in some embodiments from about 0.1 to about 4, and in some embodiments, from about 0.5 to about 3.

In particular embodiments, the textured coform web will have from about 2 and about 70 tufts per square centimeter, and in other embodiments, from about 5 and about 50 tufts per square centimeter. In certain embodiments, the textured coform web will have from about 100 to about 20,000 tufts per square meter, and in further embodiments will have from about 200 to about 10,000 tufts per square meter. The textured coform web may also exhibit a three-dimensional texture on the second surface of the web. This will especially be the case for lower basis weight materials, such as those having a basis weight of less than about 70 grams per square meter due to “mirroring”, wherein the second surface of the material exhibits peaks offset or between peaks on the first exterior surface of the material. In this case, the valley depth D is measured for both exterior surfaces as above and are then added together to determine an overall material valley depth.

Referring again to FIGS. 3 and 4, in particular embodiments the continuous region 125 comprises a plurality of uninterrupted regions 127 that extend continuously in at least one direction “D₁” without intersecting an offset region 124. Another indication of the magnitude of the three dimensionality of the texture is the ratio of the width “W₁” of the uninterrupted region 127 (measured as the largest width of the uninterrupted region in the direction perpendicular to the direction D₁ in which the uninterrupted region 127 extends without intersecting an offset region) to the width “W₂” of the offset regions 124 (measured as the largest dimension of the offset regions in the direction perpendicular to the direction D₁). In some embodiments W₁ may be in a range from about 0.01 inches to about 0.75 inches, desirably in a range from about 0.05 inches to about 0.5 inches, and more desirably in a range from about 0.08 inches to about 0.3 inches. In particular embodiments, the ratio W₁/W₂ may be in a range from about 0.3 to about 3, desirably in a range from about 0.05 inches to about 0.5 inches, and more desirably in a range from about 0.08 inches to about 0.3 inches. In particular embodiments there may additionally be a plurality of second uninterrupted regions that extend continuously in a second direction “D₂” without intersecting an offset region. In a particular embodiment, D₂ may be perpendicular to D₁, but other angles may also be used. The dimensions of the second uninterrupted regions in relation to the dimensions of the offset regions may be as described above for the first uninterrupted regions.

The coform nonwoven structure may be used in a wide variety of articles.

For example, the web may be incorporated into an “absorbent article” that is capable of absorbing water or other fluids. Examples of some absorbent articles include, but are not limited to, personal care absorbent articles, such as diapers, training pants, absorbent underpants, incontinence articles, feminine hygiene products (e.g., sanitary napkins), swim wear, baby wipes, mitt wipe, and so forth; medical absorbent articles, such as garments, fenestration materials, underpads, bedpads, bandages, absorbent drapes, and medical wipes; food service wipers; clothing articles; pouches, and so forth. Materials and processes suitable for forming such articles are well known to those skilled in the art.

In one particular embodiment, the coform web is used to form a wipe. The wipe may be formed entirely from the coform web or it may contain other materials, such as films, nonwoven structures (e.g., spunbond webs, meltblown webs, carded web materials, other coform webs, airlaid webs, etc.), paper products, and so forth. In one embodiment, for example, two layers of a textured coform web may be laminated together to form the wipe, such as described in U.S. Patent Application Publication No. 2007/0065643 to Kopacz, which is incorporated herein in its entirety by reference thereto for all purposes. In such embodiments, one or both of the layers may be formed from the coform web. In another embodiment, it may be desired to provide a certain amount of separation between a user's hands and a moistening or saturating liquid that has been applied to the wipe, or, where the wipe is provided as a dry wiper, to provide separation between the user's hands and a liquid spill that is being cleaned up by the user. In such cases, an additional nonwoven structure or film may be laminated to a surface of the coform web to provide physical separation and/or provide liquid barrier properties. Other fibrous webs may also be included to increase absorbent capacity, either for the purposes of absorbing larger liquid spills, or for the purpose of providing a wipe with a greater liquid capacity. When employed, such additional materials may be attached to the coform web using any method known to one skilled in the art, such as by thermal or adhesive lamination or bonding with the individual materials placed in face to face contacting relation. Regardless of the materials or processes utilized to form the wipe, the basis weight of the wipe is typically from about Generally speaking, the overall basis weight of the coform nonwoven structure is from about 10 gsm to about 500 gsm, and more particularly from about 17 gsm to about 200 gsm, and still more particularly from about 25 gsm to about 150 gsm. Lower basis weight products may be particularly well suited for use as light duty wipes, while higher basis weight products may be better adapted for use as industrial wipes.

The wipe may assume a variety of shapes, including but not limited to, generally circular, oval, square, rectangular, or irregularly shaped. Each individual wipe may be arranged in a folded configuration and stacked one on top of the other to provide a stack of wet wipes. Such folded configurations are well known to those skilled in the art and include c-folded, z-folded, quarter-folded configurations and so forth. For example, the wipe may have an unfolded length of from about 2 to about 80 centimeters, and in some embodiments, from about 10 to about 25 centimeters. The wipes may likewise have an unfolded width of from about 2 to about 80 centimeters, and in some embodiments, from about 10 to about 25 centimeters. The stack of folded wipes may be placed in the interior of a container, such as a plastic tub, to provide a package of wipes for eventual sale to the consumer. Alternatively, the wipes may include a continuous strip of material which has perforations between each wipe and which may be arranged in a stack or wound into a roll for dispensing. Various suitable dispensers, containers, and systems for delivering wipes are described in U.S. Pat. No. 5,785,179 to Buczwinski et al.; U.S. Pat. No. 5,964,351 to Zander; U.S. Pat. No. 6,030,331 to Zander; U.S. Pat. No. 6,158,614 to Haynes et al.; U.S. Pat. No. 6,269,969 to Huang et al.; U.S. Pat. No. 6,269,970 to Huang et al.; and U.S. Pat. No. 6,273,359 to Newman et al., which are incorporated herein in their entirety by reference thereto for all purposes.

As described above, the fibrous nonwoven structure is manufactured to have a first side with a textured surface and a second side with a substantially planar surface. This results in a wipe having a first side with a textured surface and a second side with a substantially planar surface.

The present invention may be better understood with reference to the following examples.

### Test Methods

Melt Flow Rate:

The melt flow rate (“MFR”) is the weight of a polymer (in grams) forced through an extrusion rheometer orifice (0.0825-inch diameter) when subjected to a load of 2160 grams in 10 minutes at 230° C. Unless otherwise indicated, the melt flow rate was measured in accordance with ASTM Test Method D1238-E.

Thermal Properties:

The melting temperature, crystallization temperature, and crystallization half time were determined by differential scanning calorimetry (DSC) in accordance with ASTM D-3417. The differential scanning calorimeter was a DSC Q100 Differential Scanning calorimeter, which was outfitted with a liquid nitrogen cooling accessory and with a UNIVERSAL ANALYSIS 2000 (version 4.6.6) analysis software program, both of which are available from T.A. Instruments Inc. of New Castle, Del. To avoid directly handling the samples, tweezers or other tools were used. The samples were placed into an aluminum pan and weighed to an accuracy of 0.01 milligram on an analytical balance. A lid was crimped over the material sample onto the pan. Typically, the resin pellets were placed directly in the weighing pan, and the fibers were cut to accommodate placement on the weighing pan and covering by the lid.

The differential scanning calorimeter was calibrated using an indium metal standard and a baseline correction was performed, as described in the operating manual for the differential scanning calorimeter. A material sample was placed into the test chamber of the differential scanning calorimeter for testing, and an empty pan was used as a reference. All testing was run with a 55-cubic centimeter per minute nitrogen (industrial grade) purge on the test chamber. For resin pellet samples, the heating and cooling program was a 2-cycle test that began with an equilibration of the chamber to −25° C., followed by a first heating period at a heating rate of 10° C. per minute to a temperature of 200° C., followed by equilibration of the sample at 200° C. for 3 minutes, followed by a first cooling period at a cooling rate of 10° C. per minute to a temperature of −25° C., followed by equilibration of the sample at −25° C. for 3 minutes, and then a second heating period at a heating rate of 10° C. per minute to a temperature of 200° C. All testing was run with a 55-cubic centimeter per minute nitrogen (industrial grade) purge on the test chamber. The results were then evaluated using the UNIVERSAL ANALYSIS 2000 analysis software program, which identified and quantified the melting and crystallization temperatures.

The half time of crystallization was separately determined by melting the sample at 200° C. for 5 minutes, quenching the sample from the melt as rapidly as possible in the DSC to a preset temperature, maintaining the sample at that temperature, and allowing the sample to crystallize isothermally. Tests were performed at two different temperatures, i.e., 125° C. and 130° C. For each set of tests, heat generation was measured as a function of time while the sample crystallized. The area under the peak was measured and the time which divides the peak into two equal areas was defined as the half-time of crystallization. In other words, the area under the peak was measured and divided into two equal areas along the time scale. The elapsed time corresponding to the time at which half the area of the peak was reached was defined as the half-time of crystallization. The shorter the time, the faster the crystallization rate at a given crystallization temperature.

Wipe Cleaning Test for Cleaning Pickup Percentage:

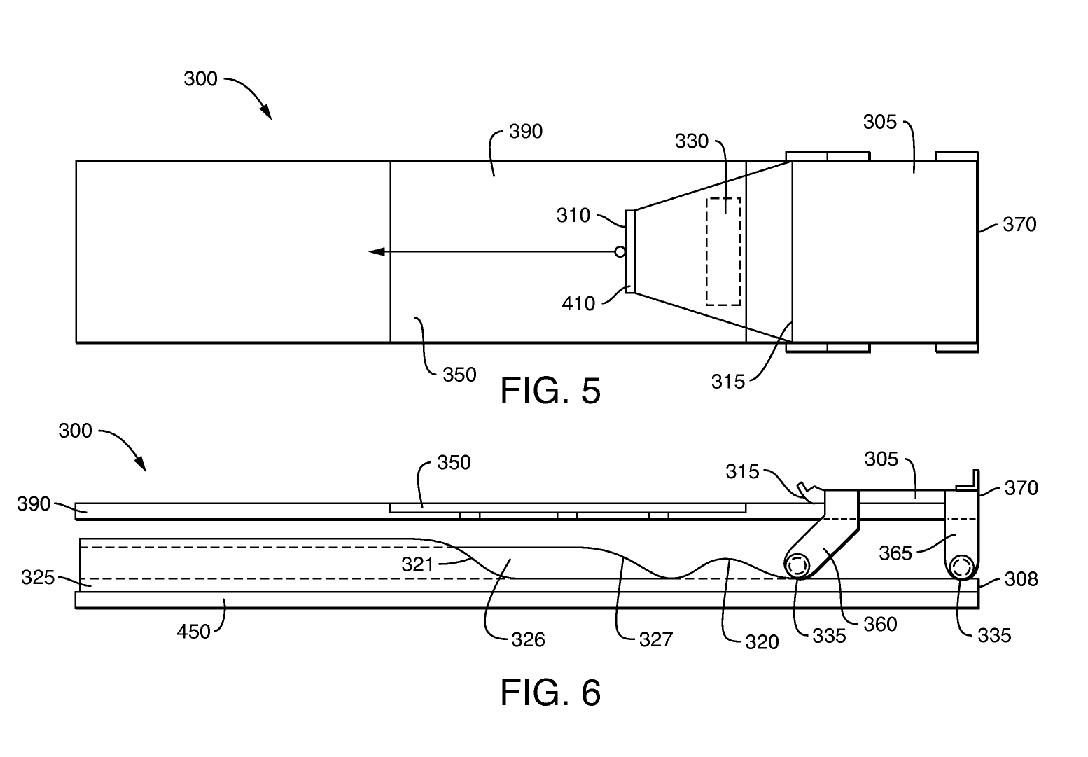

The cleaning percentage test is designed to simulate the actual wiping motion involving cupping, wiping and lifting using the apparatus 300 illustrated in FIGS. 5-9. During the test, a modified ASTM 6702-01 sled 305 with a wet wipe attached begins moving forward at a relatively slow rate of speed (40 inches/min) in a horizontal motion. The sled 305 is connected to a drive source (e.g., tensile frame cross-head or a PLC controlled drive motor—not shown) via a lanyard 310, as depicted in FIG. 5. Shortly after the sled 305 begins moving, its leading end 315 is lifted upward as the wheels 326 supporting the sled 305 encounter a first outer ramp 320 on an outer rail 326 having a height of 0.48 inches. At the apex of the 0.48 inch first outer ramp 320, the sled 305 speeds up to 250 inches/min, descends down the first outer ramp 320 to contact a Feclone sample 330, then continues wiping the Feclone in a horizontal fashion for about 4.25 inches (when the wheel-rail gap is 0.030 inches) before ascending along the inner and outer rails 326, 325 and stopping just short of the opposite end.

To prepare for the test, the removable test plate 350 is placed on a laboratory balance and the weight recorded to the nearest 0.00 gram. The test plate 350 is 8.75 inches long, and is located 5.63 inches from the back edge 308 of the apparatus 300. With the plate 350 remaining on the balance pan, the balance is zeroed to tare the weight of the plate. Four grams ±0.2 g of Feclone 13—Brown, a simulated feces formulation mixed to a ratio of 1 part Feclone to six parts distilled water, is mixed per vendor mixing instructions, and then extruded from a 60 cc syringe directly onto the test plate. Placement of the Feclone is centered along the length of a 0.75 inch×2.63 inch sample area 330 located approximately 5.95 inches from the front edge of the apparatus on the test plate as shown in FIG. 5. (Feclone 13—Brown is available from Silicone Studio, Valley Forge, Pa.). The weight of the Feclone sample is recorded to the nearest hundredth of a gram. The test plate 350 is removed, the balance is re-zeroed and the test plate is installed back into position. After application of the Feclone to the sample area 330, the sled 305 is manually positioned near the maximum forward position for wipe specimen mounting (see FIG. 5, left side).

To prepare a wipe sample for testing, a nonwoven structure wetted with a liquid solution is die-cut to 4.5 inches by 7 inches and is attached to a sled. A single wipe is attached with two (2) ¾ inch wide, pinch type binder clips (or equivalent) along the leading edge (nose) of the sled (near the front end corners). Two additional clips are used to attach the wipe to a piece of 0.5 inch×0.5 inch aluminum angle mounted to the back side of the sled. Care is taken not to stretch the wipe during mounting. With the wipe mounted, the sled 305 is returned to the opposite end, taking care not to disturb the Feclone sample. Test start position is with the back end 370 of the sled 305 flush with the back edge 308 of the test apparatus 300 (see FIG. 5). To initiate the test, any lanyard 310 slack is removed and the motor that pulls the sled 305 forward is activated. When the sled 305 stops, the test plate 350 is removed and reweighed and a Post Test Weight is recorded. Ten samples are tested and the mean is the cleaning pickup percentage.

The pickup efficiency is calculated as follows:

Cleaning Pickup Percentage (%)=(Post Test Weight)/(Dry Plate Weight+Feclone Weight)×100

Prior to subsequent testing, test plates are washed with a mild detergent in water, then rinsed with distilled water and dried.

The wiping test described herein is a modification of ASTM D 6702-01. It is an improvement of the ASTM test, in that it adds a more realistic feces wiping action, particularly the action of a mom or caregiver, i.e., a lift, trap, and swipe action. The sled described in ASTM D 6702-01 was used for the test used in this application, but modified for the purposes of this test. Referring to FIGS. 5 and 6, note that the sled area of the ASTM D 6702-01 design was maintained, but the sled material used for this testing was aluminum. The center of the sled 305 was tapped to support a stud, over which washers of various weights could be added to experiment with various wiping pressures. Washers are held in place with a wing nut. In addition, a ½ inch×½ inch aluminum angle was added, as mentioned above. The total sled 305 weight for the testing described herein is 1,065 g.

Also, the sled 305 has been modified by two sets of tapped holes added to each side of the sled to place sled support legs 360, 365. The front hole sets were drilled into the side of the sled for #8-32 holes approximately 3.12 inches and 3.49 inches from the back of the sled 305 at the midpoint of the sled height. The back hole sets were drilled into the side of the sled for #8-32 holes approximately 0.19 inches and 0.56 inches from the back of the sled at the midpoint of the sled height. The front sled supports 360 are bolted into the two front hole sets, and the back sled supports 365 are bolted into the two back hole sets. The front of the front sled support 360 angles forward at an angle of 45° 0.68 inches from the top of the front sled support 360 and the back of the front sled support 360 angles forward at an angle of 45° 1 inch from the top of the front sled support 360. The front sled supports 360 have a total height of 2.18 inches. The back sled supports 365 have a height of 2.18 inches long and are straight.

Each of the front and back sled supports 360, 365 have a slot near their bottom portions. The slots are 0.18 inches wide by 0.28 inches long. These slots are used to mount the wheels 326 that contact the rails at the beginning and end of the test. The wheels are positioned to have a clearance of 0.03 inches above the rails. The wheels are metric track rollers, 12 mm in DIA. by 8 mm wide, and are available from McMaster-Carr Supply Co., Chicago, Ill., part number 6314K15. The wheels 326 contain a stud that fastens to the supports with a small nut. For the front sled supports 360, wheels 326 are attached with the nuts to the inside (toward machine centerline); for back sled supports 365, wheels are attached with nuts to the outside.

The basic test apparatus 300 is depicted in an assembly schematic shown as FIG. 5. The elevation view of FIG. 5 shows the sled 305 in the test start position, the test plate nestled into the top surface (the surrounding surfaces are made from an oil impregnated material called Nylatrol™). The test plate 350 has two blind holes on one end (not shown) which support locating pins to ensure that the plate is precisely positioned for every test, eliminating any chance that the test plate 350 edges are not flush with adjacent top plate edge surfaces, critical to prevent binding or damage to the sled and lanyard when the sled 305 is being pulled. FIG. 5 also shows the lanyard 310 arrangement used to pull the sled 305 forward. The lanyard 310 includes a tube 410 that is attached to the motor (not shown). The ends of the tube 410 are attached to the side of the front edge of the sled 305 so that the lanyard 310 does not touch the sample area 330.

FIG. 5 also shows that the rails are to be fastened to a base plate such that the right side edge is flush with the right side edge of the top plate. Also note that the sled rides along rails that change the sled elevation at the beginning and after the end of the wiping sequence, and that the initial speed of 40 inches per minute changes to 250 inches per minute at the apex of the first outside rail incline approximately 6.19 inches from the front edge of the test apparatus.

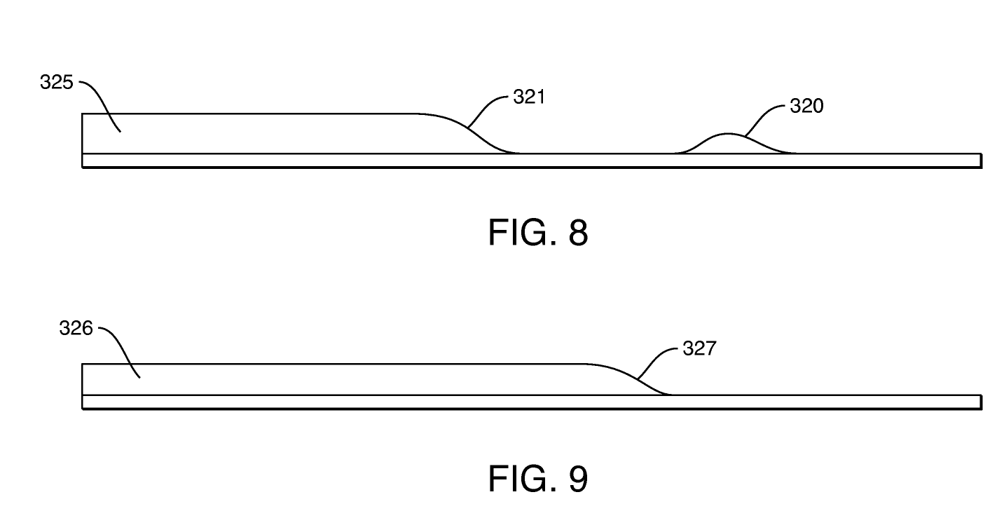

A detailed view of the outer rails 325 is provided as FIG. 8. The front sled supports 360 travels along the outer rails 325 and provides a first outer ramp 320 to simulate a consumer cupping, a flat area to simulate wiping, and a second outer ramp 321 to simulate lifting of the wipe. The outer rails 325 run along a linear path and then curve upward to create a first outer ramp 320. At this point, the outer rails 325 ramp upwards from their initial height defined by a concave circle with a radius of 1 inch centered 4.75 inches from the back edge 308 of the apparatus to a convex circle with a radius of 0.8 inches centered 6.19 inches from the back edge 308 of the apparatus 300 reaching a maximum height of 0.48 inches, and returning to its initial height along a concave circle with a radius of 1 inch centered 6.19 inches from the back edge 308 of the apparatus 300. The inner rails do not curve upward at this point. Thus, only the leading wiping edge 307 of the sled 305 rises from the testing surface 390 that is being wiped.

The outer rails 325 then pass along a linear path so that the test sled passes across the testing surface 390 being wiped to contact and pick up the material being wiped and simulating a wiping motion. At this point, both of the outer rails 320 ramp upwards at a second outer ramp 322 from their initial height defined by a convex circle with radius of 1.93 inches centered 10.97 inches from the front edge of the apparatus to a concave circle with a radius of 1.93 inches centered 13.49 inches from the front edge of the apparatus to reach a total height of 1.3 inches. The ramp has a total length of 22.3 inches.

A detailed view of the inner rails is provided as FIG. 9. The inner rails 326 pass along a linear path until both the of inner rails ramp upwards at a first inner ramp 327 from their initial height defined by a concave circle with radius of 1.93 inches centered 7.24 inches from the front edge of the apparatus to a convex circle with a radius of 1.93 inches centered 9.49 inches from the front edge of the apparatus to reach a total height of 1.13 inches. The ramp has a total length of 22.3 inches. The front sled supports contact the second outer ramp at the same time the back sled supports contact the first inner ramp so that both the front and back of the sled rise to simulate lifting.

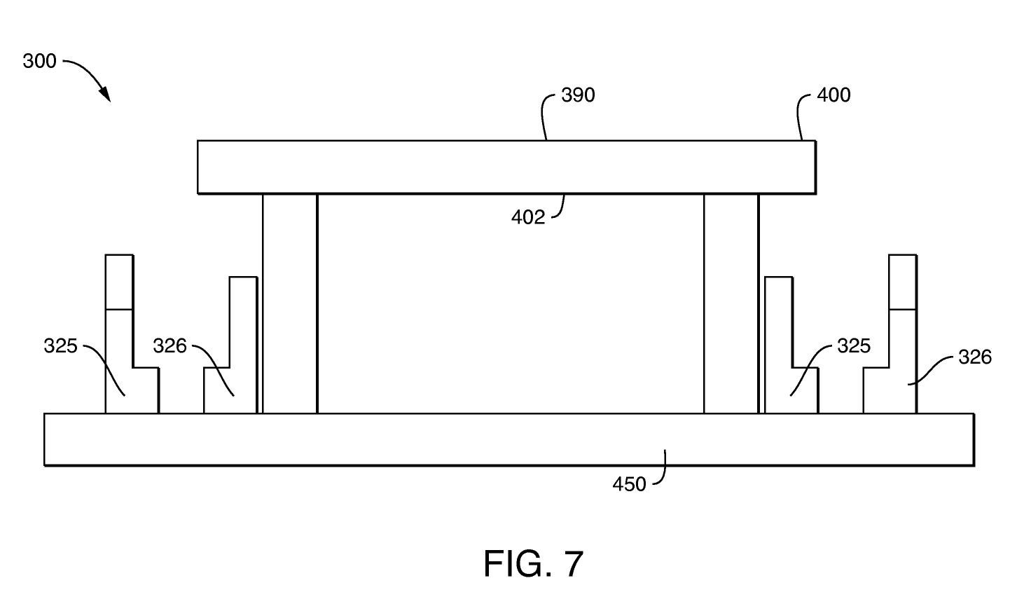

FIG. 7 illustrates an end view for the test start end to illustrate the spacing of the rails and the relationship between the testing surface 390 and the rail mounting base plate 450. A 0.002 inch clearance is needed between the sled 305 and the top edge 400 of the testing surface 390. The top edge 400 is 2.22 inches high and the bottom edge 402 of the testing surface is 1.83 inches high. The two rails are approximately 0.38 inches apart.

### EXAMPLE 1

A coform web was formed from two heated streams of meltblown fibers and a single stream of fiberized pulp fibers as described above and shown in FIG. 1. The meltblown fibers were formed from Metocene MF650X, a propylene homopolymer having a density of 0.91 g/cm³ and melt flow rate of 1200 g/10 minute (230° C., 2.16 kg), which is available from Basell Polyolefins. The pulp fibers were fully treated southern softwood pulp obtained from the Weyerhaeuser Co. of Federal Way, Wash. under the designation “CF-405.”

The polypropylene of each stream was supplied to respective meltblown dies at a rate of 1.5 to 2.5 pounds of polymer per inch of die tip per hour to achieve a meltblown fiber content ranging from 25 wt. % to 40 wt. %. The distance from the impingement zone to the forming wire (i.e., the forming height) was approximately 8 inches and the distance between the tips of the meltblown dies was approximately 5 inches. The meltblown die positioned upstream from the pulp fiber stream was oriented at an angle of 50° relative to the pulp stream, while the other meltblown die (positioned downstream from the pulp stream) was oriented between 42 to 45° relative to the pulp stream. The forming wire was FORMTECH™ 8 (Albany International Co.). To achieve the desired texture, a rubber mat was disposed on the upper surface of the forming wire. A mat having a thickness of approximately 0.95 centimeters and containing cloud shapes arranged in a hexagonal array was used. A vacuum box was positioned below the forming wire to aid in deposition of the web and was set to 30 inches of water. The coform web has a substantially planar side and a textured side with a cloud pattern.

### EXAMPLE 2

A coform web was formed from two heated streams of meltblown fibers and a single stream of fiberized pulp fibers as described above and shown in FIG. 1. The meltblown fibers were formed from Vistamaxx 7001-3, a blend of 85 wt. % propylene homopolymer (Achieve 6936G) and 15 wt. % propylene/ethylene copolymer (Vistamaxx 2330, density 0.868 g/cm3, meltflow rate of 290 g/10 minutes (230° C., 2.16 kg)) having a density of 0.89 g/cm3 and a melt flow rate of 540 g/10 minutes (230° C., 2.16 kg), which is available from ExxonMobil Corp. The pulp fibers were fully treated southern softwood pulp obtained from the Weyerhaeuser Co. of Federal Way, Wash. under the designation “CF-405.”

The polypropylene of each stream was supplied to respective meltblown dies at a rate of 1.5 to 2.5 pounds of polymer per inch of die tip per hour to achieve a meltblown fiber content ranging from 25 wt. % to 40 wt. %. The distance from the impingement zone to the forming wire (i.e., the forming height) was approximately 8 inches and the distance between the tips of the meltblown dies was approximately 5 inches. The meltblown die positioned upstream from the pulp fiber stream was oriented at an angle of 50° relative to the pulp stream, while the other meltblown die (positioned downstream from the pulp stream) was oriented between 42 to 45° relative to the pulp stream. The forming wire was FORMTECH™ 8 (Albany International Co.). To achieve the desired texture, a rubber mat was disposed on the upper surface of the forming wire. A mat having a thickness of approximately 0.95 centimeters and containing squares having sides with a length of 0.375 inches spaced 0.250 inches apart arranged in a hexagonal array was used. A vacuum box was positioned below the forming wire to aid in deposition of the web and was set to 30 inches of water. The coform web has a substantially planar side and a textured side with a square pattern.

### COMPARATIVE EXAMPLE 1

Various samples of coform webs were formed from two heated streams of meltblown fibers and a single stream of fiberized pulp fibers as described above and shown in FIG. 1. The meltblown fibers were formed from the polypropylene samples referenced in Example 1. The pulp fibers were fully treated southern softwood pulp obtained from the Weyerhaeuser Co. of Federal Way, Wash. under the designation “CF-405.”

The polypropylene of each stream was supplied to respective meltblown dies at a rate of 1.5 to 2.5 pounds of polymer per inch of die tip per hour to achieve a meltblown fiber content ranging from 25 wt. % to 40 wt. %. The distance from the impingement zone to the forming wire (i.e., the forming height) was approximately 8 inches and the distance between the tips of the meltblown dies was approximately 5 inches. The meltblown die positioned upstream from the pulp fiber stream was oriented at an angle of 50° relative to the pulp stream, while the other meltblown die (positioned downstream from the pulp stream) was oriented between 42 to 45° relative to the pulp stream. The forming wire was FORMTECH™ 8 (Albany International Co.) as the only forming surface. A vacuum box was positioned below the forming wire to aid in deposition of the web and was set to 30 inches of water. The coform web has a substantially planar side and a textured side formed with the wire surface.

### Experiment 1

The coform webs made in Examples 1 and 2 and Comparative Example 1 were wetted with a liquid solution provided with HUGGIES Natural Care® Fragrance Free Baby Wipes (commercially available from Kimberly-Clark Corp.) at an add-on rate of 270% to form a wet wipe. Each wipe was tested to find the cleaning pickup percentage as described above. Table 1 below illustrates the values found for the difference in cleaning pickup percentage between the textured and smooth side of the wipe for the various samples.

TABLE 1
Difference in Cleaning Pickup Percentage Values

| | Difference in |
|---|---|
| Sample | Cleaning Pickup % |
| Example 1 | 29.8% |
| Example 2 | 11.2% |
| Comparative Example 1 | 34.5% |

As can be seen in the above examples, the wet wipes prepared have a difference in cleaning pickup percentage of less than 30%, while prior art examples have a difference in cleaning pickup percentage of 34.5%. As evidenced by Example 2, use of Vistamaxx 7001-3, a meltblown fibrous material that is made from a thermoplastic composition having at least one propylene/α-olefin, results in a wet wipe with a better two sided sheet. The difference in cleaning pickup percentage of Example 2 is 11.2%.

While the invention has been described in detail with respect to the specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

1. A wet wipe comprising:
a nonwoven structure formed from a matrix at least one meltblown fibrous material and at least one secondary fibrous material, wherein a weight ratio of the at least one secondary fibrous material to the at least one meltblown fibrous material is in between about 40/60 to about 90/10, wherein a basis weight of the fibrous nonwoven structure is in a range of about 20 gsm to about 500 gsm;
the nonwoven structure having a first side with a textured surface having a three-dimensional texture that includes a plurality of peaks and valleys and a second side with a substantially planar surface;
about 150 to about 600 wt. % of a liquid solution based on the dry weight of the nonwoven structure; and
wherein a difference in a cleaning pickup percentage between the first side and the second side is less than 30%.

2. The wet wipe of claim 1 wherein the difference in a cleaning pickup percentage between the first side and the second side is less than 20%.

3. The wet wipe of claim 1 wherein the difference in a cleaning pickup percentage between the first side and the second side is less than 15%.

4. The wet wipe of claim 1, wherein at least one meltblown fibrous material is made from a thermoplastic composition having at least one propylene/α-olefin copolymer having a propylene content of from about 60 mole % to about 99.5 mole % and an α-olefin content of from about 0.5 mole % to about 40 mole %.

5. The wet wipe of claim 4, wherein propylene constitutes from about 85 mole % to about 98 mole % of the copolymer and the α-olefin constitutes from about 2 mole % to about 15 mole % of the copolymer.

6. The wet wipe of claim 4, wherein the thermoplastic composition has a density of from about 0.88 to about 0.92 grams per cubic centimeter.

7. The wet wipe of claim 4, wherein the propylene copolymer is single-site catalyzed.

8. The wet wipe of claim 4, wherein the melt flow rate of the thermoplastic composition is from about 400 to about 1500 grams per 10 minutes.

9. The wet wipe of claim 1, wherein the secondary fibrous material contains pulp fibers.

10. The wet wipe of claim 4, wherein the meltblown fibers constitute from 1 wt. % to about 40 wt. % of the web and the secondary fibrous material constitutes from about 60 wt. % to about 99 wt. % of the web.

11. The wet wipe of claim 1, wherein the meltblown fibers constitute from 5 wt. % to about 20 wt. % of the web and the secondary fibrous material constitutes from about 80 wt. % to about 95 wt. % of the web.

12. The wet wipe of claim 1, wherein the propylene/α-olefin copolymer constitutes at least about 1 wt. % and less than about 49 wt. % of the thermoplastic composition.

13. The wet wipe of claim 4 wherein the difference in a cleaning pickup percentage between the first side and the second side is less than 15%.

14. The wet wipe of claim 1 wherein the nonwoven structure is coform.

15. The wet wipe of claim 1 wherein the matrix comprises a continuous region and a plurality of offset regions, the continuous region having a cross direction, a machine direction, and a thickness, the continuous region further comprising a planar first side extending in the cross direction and the machine direction and a second planar side opposite the first side, the first and second sides being separated by the thickness of the continuous region, the offset regions extending out from the first side, wherein the offset regions are positioned to define a plurality of first uninterrupted portions of the continuous regions, wherein the first uninterrupted portions of the continuous region do not underlie any offset regions, further wherein the first uninterrupted portions of the continuous region extend in a first direction in the plane of the first side, the first direction not intersecting any offset regions, and further wherein the width of the uninterrupted portions divided by the width of the offset regions is between about 0.3 and about 2, the widths measured perpendicular to the first direction in the plane of the first side, and even further wherein the continuous region extends completely under the offset regions.
